(19) United States
(12) Patent Application Publication
(10) Pub. No.: US 2024/0420897 A1
(43) Pub. Date: Dec. 19, 2024

(54) Solid Electrolytic Capacitor and Method for Producing Solid Electrolytic Capacitor

(71) Applicant: KYOCERA AVX Components Corporation, Fountain Inn, SC (US)

(72) Inventor: Naotsugu Sugimura, Kyoto (JP)

(21) Appl. No.: 18/262,756

(22) PCT Filed: Jan. 17, 2022
(86) PCT No.: PCT/JP2022/001316

§ 371 Date: Jul. 25, 2023

(30) Foreign Application Priority Data
Feb. 1, 2021 (JP) 2021-014239

(51) Int. Cl. H01G 9/00; H01G 9/028; H01G 9/052; H01G 9/07; H01G 9/15

(52) U.S. Cl. CPC H01G 9/0036; H01G 9/0032; H01G 9/028; H01G 9/052; H01G 9/07; H01G 9/15

(57) ABSTRACT

This solid electrolytic capacitor is provided with: a porous sintered body that constitutes a positive electrode; a dielectric layer that is formed on the porous sintered body; a solid electrolyte layer that is formed on the dielectric layer; and a conductor layer that is formed on the solid electrolyte layer so as to constitute a negative electrode. The solid electrolyte layer comprises a first layer that is formed on the dielectric layer. The first layer contains an electrolyte solution. The electrolyte solution is composed, for example, of at least one substance that is selected from the group consisting of ethylene glycol, dimethylformamide, γ-butyrolactone, a polyalkylene glycol, a polyalkylene triol, and derivatives of these compounds. Alternatively, the electrolyte solution is composed of a polymer-based electrolyte solution or a carbonate-based electrolyte solution.

### TECHNICAL FIELD

The present disclosure relates to the solid electrolytic capacitor and method of manufacturing the solid electrolytic capacitor.

### BACKGROUND TECHNOLOGY

Various solid electrolytic capacitors having a structure in which a porous sintered body of metal, a dielectric layer and a solid electrolyte layer are laminated have been proposed. Patent Literature 1 discloses an example of a conventional solid electrolytic capacitor.

### CITATION LIST

### Patent Literature

Patent Literature 1: Japanese Unexamined Patent Application Publication No. 2017-092237

### SUMMARY OF THE INVENTION

### Problems to be Solved by the Invention

In order to use solid electrolytic capacitors in a wider range of applications, it is preferable to increase the withstand voltage of solid electrolytic capacitors. Further, solid electrolytic capacitors are desired to have a larger capacitance relative to the overall size.

In view of the circumstances described above, an object of the present disclosure is to provide a solid electrolytic capacitor capable of improving the withstand voltage and increasing the electrostatic capacity. Another object of the present disclosure is to provide a method for the manufacturing such a solid electrolytic capacitor.

### Means for Solving the Problems

A solid electrolytic capacitor provided by a first aspect of the present disclosure comprises a porous sintered body constituting an anode, a dielectric layer formed on the porous sintered body, a solid electrolyte layer formed on the dielectric layer, and a conductor layer formed on the solid electrolyte layer and constituting a cathode. The solid electrolyte layer includes a first layer formed on the dielectric layer, and the first layer includes an electrolytic solution.

A method for the manufacturing of a solid electrolytic capacitor provided by the second aspect of the present disclosure includes the steps of: forming a porous sintered body constituting an anode, forming a dielectric layer on the porous sintered body, forming a solid electrolyte layer on the dielectric layer, and forming a conductor layer constituting a cathode on the solid electrolyte layer. The step of forming the solid electrolyte layer includes a first treatment of forming the first layer using a first liquid containing an electrolytic solution.

### Effects of Invention

According to the above configuration, it is possible to obtain a solid electrolytic capacitor capable of improving the withstand voltage and increasing the capacitance.

Other features and advantages of the present disclosure will become more apparent by the detailed description given below with reference to the accompanying drawings.

### BRIEF DESCRIPTION OF THE DRAWING

FIG. 1 is a cross-sectional view illustrating a solid electrolytic capacitor according to a first embodiment of the present disclosure.

FIG. 2 is an enlarged cross-sectional view of a key portion illustrating a solid electrolytic capacitor according to a first embodiment of the present disclosure.

FIG. 3 is an enlarged cross-sectional view of a key schematically depicting a solid electrolytic capacitor according to a first embodiment of the present disclosure.

FIG. 4 is a flow diagram illustrating an example of a method of making a solid electrolytic capacitor according to a first embodiment of the present disclosure.

FIG. 5 is a cross-sectional view illustrating a method of making a solid electrolytic capacitor according to a first embodiment of the present disclosure.

FIG. 6 is a cross-sectional view illustrating a method of making a solid electrolytic capacitor according to a first embodiment of the present disclosure.

FIG. 7 is an enlarged cross-sectional view of a key schematically illustrating a first variant of a solid electrolytic capacitor according to a first embodiment of the present disclosure.

FIG. 8 is an enlarged cross-sectional view of a key schematically depicting a solid electrolytic capacitor according to a second embodiment of the present disclosure.

FIG. 9 is an enlarged cross-sectional view of a key schematically depicting a solid electrolytic capacitor according to a third embodiment of the present disclosure.

FIG. 10 is an enlarged cross-sectional view schematically showing a solid electrolytic capacitor according to a fourth embodiment of the present disclosure.

### MODES FOR CARRYING OUT THE INVENTION

Preferred embodiments of the present disclosure will be specifically described below with reference to the drawings.

Terms such as “first,” “second,” “third,” etc. in this disclosure are used to distinguish terms from one another and are not intended to rank the objects.

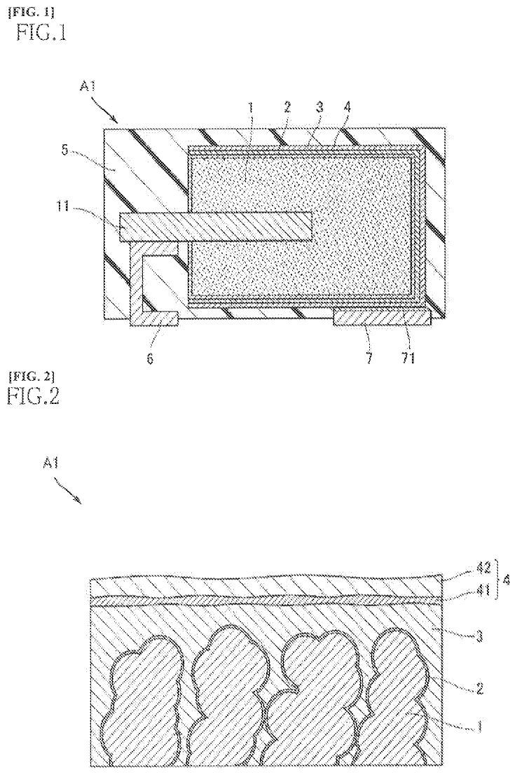

FIGS. 1-3 illustrate a solid electrolytic capacitor according to a first embodiment of the present disclosure. The solid electrolytic capacitor A1 of this embodiment comprises a porous sintered body 1, a dielectric layer 2, a solid electrolyte layer 3, a conductor layer 4, a sealing resin 5, an anode terminal 6 and a cathode terminal 7.

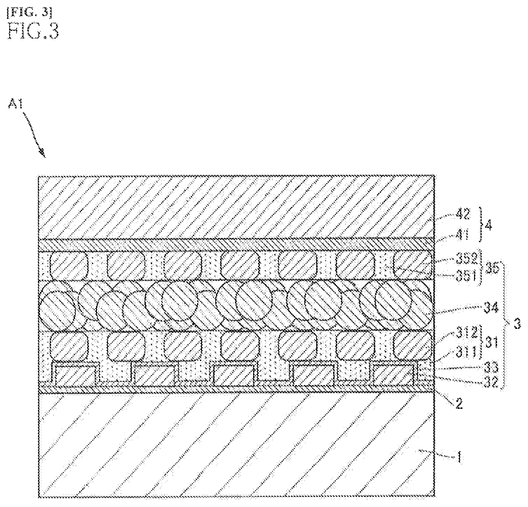

FIG. 1 is a cross-sectional view illustrating a solid electrolytic capacitor A1. FIG. 2 is an enlarged cross-sectional view of a central portion showing a solid electrolytic capacitor A1. FIG. 3 is an enlarged cross-sectional view of a key schematically depicting a solid electrolytic capacitor A1.

Porous sintered body 1 constitutes an anode and consists of a valve metal (e.g., tantalum (Ta) or niobium (Nb)). The shape of the porous sintered body 1 (macro shape that can be recognized by external observation) is not particularly limited, and is, for example, a rectangular parallelepiped shape. In the present embodiment, the anode wire 11 is secured to the porous sintered body 1. The anode wire 11 is partly penetrated into the interior of the porous sintered body 1. The anode wire 11 consists of, for example, tantalum or niobium, which is a valve metal. The porous sintered body 1 has a number of micropores (pores) within it.

The dielectric layer 2 is formed on the porous sintered body 1. In the illustrated example, the dielectric layer 2 is laminated to the surface of the porous sintered body 1. As described above, the porous sintered body 1 is a structure having a number of pores. As such, the dielectric layer 2 not only covers the outer surface of porous sintered body 1 (the surface that appears externally), but also covers at least some of the inner surfaces of the pores (for example, those relatively close to the outer surface of the porous sintered body 1) (see FIG. 2). The dielectric layer 2 generally consists of an oxide of a valve metal, such as tantalum pentoxide (Ta₂O₅) or niobium pentoxide (N₂bO₅).

A solid electrolyte layer 3 is formed on the dielectric layer 2 and covers the dielectric layer 2. As shown in FIG. 3, the solid electrolyte layer 3 of this embodiment includes a first layer 31, a second layer 32, a third layer 33, a fourth layer 34, and a fifth layer 35.

The first layer 31 is formed on the dielectric layer 2. It should be noted that the phrase “the first layer 31 is formed on the dielectric layer 2” is not limited to the form in which the first layer 31 is entirely in contact with the dielectric layer 2. For example, another layer (for example, either or both of the second layer 32 and the third layer 33) may be interposed between the first layer 31 and the dielectric layer 2. As shown in FIG. 3, the first layer 31 includes an electrolyte 311 and a conductive polymer 312. The electrolyte 311 is filled between the dispersions or self-doped polymers of the second layer 32 (described below). Electrolytes 311 include, for example, ethylene glycol, dimethylformamide, γ-butyrolactone, polyethylenealkylene glycol, polyalkylenetriol (or the derivatives thereof), polymer-based electrolytes, and carbonate-based electrolytes (for example, ethylene carbonate, propylene carbonate, etc.). As an example, electrolyte 311 includes at least one of (1) at least one selected from the group consisting of ethylene glycol, dimethylformamide, γ-butyrolactone, polyethylenealkylene glycol, polyalkylenetriol (or the derivatives thereof), (2) a polymer-based electrolyte, and (3) a carbonate-based electrolyte. This is also true for electrolyte 351 included in layer 535, described below. In addition, it is desirable to have a liquid that does not evaporate due to the temporary heat of reflow as the performance required as an electrolyte. Additives can be used as solutes to improve the conductivity of the electrolyte 311. Such additives can include, for example, various anions such as adipic acid, carboxylic acid, sulfonic acid, and the like. The conductive polymer 312 is a dispersion or self-doped polymer of the conductive polymer. The dispersion consists of, for example, polypyrrole, polythiophene, polyaniline, polyfuran, or a polymer or copolymer containing one or two selected from derivatives having the above substances as a basic skeleton, and various adipic acids, carboxylic acids, and sulfonic acids. Self-doped polymers include conductive polymers based on, for example, polypyrrole, polythiophene, polyaniline, polyfuran, and induced by electron donating groups such as adipic acid, carboxylic acid, sulfonic acid, and the like.

The second layer 32 is formed on the dielectric layer 2. The second layer 32 has a dispersion or self-doped polymer consisting of a conductive polymer. The dispersion or self-doped polymer that constitutes the second layer 32 is in contact with the dielectric layer 2. Also, the dispersion or self-doped polymer that constitutes the second layer 32 covers a portion of the dielectric layer 2. That is, the dielectric layer 2 has a portion that is not covered by the second layer 32. In other words, the dielectric layer 2 has a portion exposed from the second layer 32. The portion of the dielectric layer 2 that comes into contact with the electrolyte 311 is the portion of the dielectric layer 2 that is not covered by the second layer 32. The dispersions that constitute the second layer 32 comprises of, for example, polypyrrole, polythiophene, polyaniline, polyfuran, or a polymer or copolymer containing one or two selected from derivatives having the above substances as a basic skeleton, and various adipic acids, carboxylic acids, and sulfonic acids. The self-doped polymers that make up the second layer 32 are conductive polymers that are based on, for example, polypyrrole, polythiophene, polyaniline, polyfuran, and induced by electron donor groups such as adipic acid, carboxylic acid, sulfonic acid, and the like.

A third layer 33 interposes the first layer 31 and the second layer 32. The third layer 33 covers the dispersion or self-doped polymer of the first layer 31 and the dielectric layer 2. It should be noted that at least a portion of either of the dielectric layer 2 and the second layer 32 may be configured to be exposed from the third layer 33. In this case, the portion of the dielectric layer 2 and the second layer 32 that is not covered by the third layer 33 is in contact with the electrolyte 311. The third layer 33 consists of a conductive polymer and is formed by chemical polymerization. The third layer 33 consists of, for example, a polymer or copolymer comprising one or two selected from polypyrroles, polythiophenes, polyaniline, polyfurans, or derivatives based on the substances, and includes various adipic, carboxylic, sulfonic acids as dopants.

The fourth layer 34 interposes the first layer 31 and the conductor layer 4. The fourth layer 34 consists of a dispersion of conductive polymers or self-doped polymers. The dispersions that make up the fourth layer 34 comprises of, for example, a polymer or copolymer consisting of one or two species selected from polypyrroles, polythiophenes, polyaniline, polyfuran, or derivatives based on the substances, and include various adipic acids, carboxylic acids, sulfonic acids as dopants. The self-doped polymers that make up the fourth layer 34 are conductive polymers that are based on, for example, polypyrrole, polythiophene, polyaniline, polyfuran, and induced by electron donor groups such as adipic acid, carboxylic acid, sulfonic acid, and the like. Depending on the formation state of the dispersion or self-doped polymer that constitutes the fourth layer 34, the fourth layer 34 may be infiltrated with, for example, electrolyte 311 of the first layer 31 or electrolyte 351 of the fifth layer 35 described below, or it may be in a configuration in which electrolyte 311 or electrolyte 351 is not infiltrated. In the example shown in FIG. 3, the fourth layer 34 is described as an aspect in which the electrolyte 311 and the electrolyte 351 are not infiltrated.

The fifth layer 35 interposes the fourth layer 34 and the conductor layer 4. The fifth layer 35 has an electrolyte 351 and a conductive polymer 352. Electrolytes 351 include, for example, ethylene glycol, dimethylformamide, γ-butyrolactone, polyethylenealkylene glycol, polyalkylenetriol (or the derivatives thereof), polymer-based electrolytes, and carbonate-based electrolytes (for example, ethylene carbonate, propylene carbonate, etc.). In addition, it is desirable to have a liquid that does not evaporate due to the temporary heat of reflow as the performance required as an electrolyte. Additives can be used as solutes to improve the conductivity of the electrolyte 351. Such additives can include, for example, various anions such as adipic acid, carboxylic acid, sulfonic acid, and the like. The conductive polymer 352 is also a dispersion or self-doped polymer consisting of conductive polymers. The dispersion consists of, for example, polypyrrole, polythiophene, polyaniline, polyfuran, or a polymer or copolymer containing one or two selected from derivatives having the above substances as a basic skeleton, and various adipic acids, carboxylic acids, and sulfonic acids. Self-doped polymers include conductive polymers based on, for example, polypyrrole, polythiophene, polyaniline, polyfuran, and induced by electron donating groups such as adipic acid, carboxylic acid, sulfonic acid, and the like.

The conductor layer 4 is formed on the solid electrolyte layer 3 and constitutes a cathode. The specific configuration of the conductor layer 4 is not particularly limited as long as it is made of a conductor. In the present embodiment, the conductor layer 4 includes a base layer 41 and a top layer 42. The base layer 41 consists, for example, of graphite. In the present embodiment, the base layer 41 is in contact with the fifth layer 35 of the solid electrolyte layer 3. The top layer 42 is formed on the base layer 41, and is made up of, for example, silver (Ag).

The sealing resin 5 covers the porous sintered body 1, the anode wire 11, the dielectric layer 2, the solid electrolyte layer 3 and the conductor layer 4. The sealing resin 5 consists of an insulating resin such as, for example, an epoxy resin.

The anode terminal 6 is joined to the anode wire 11 and partly exposed from the sealing resin 5. The anode terminal 6 consists of a Ni-Fc alloy, such as a 42-alloy, plated with copper (Cu). The site exposed from the sealing resin 5 of the anode terminal 6 is used as a mounting terminal for surface mounting the solid electrolytic capacitor A1.

The cathode terminal 7 is bonded to the conductor layer 4 via an electrically conductive bonding material 71, such as silver, some of which is exposed from the sealing resin 5. The cathode terminal 7 consists of a Ni—Fe alloy, such as a 42-alloy, plated with copper (Cu). The site exposed from the sealing resin 5 of the cathode terminal 7 is used as a mounting terminal for surface mounting the solid electrolytic capacitor A1.

The method of making solid electrolytic capacitor A1 shall be described below.

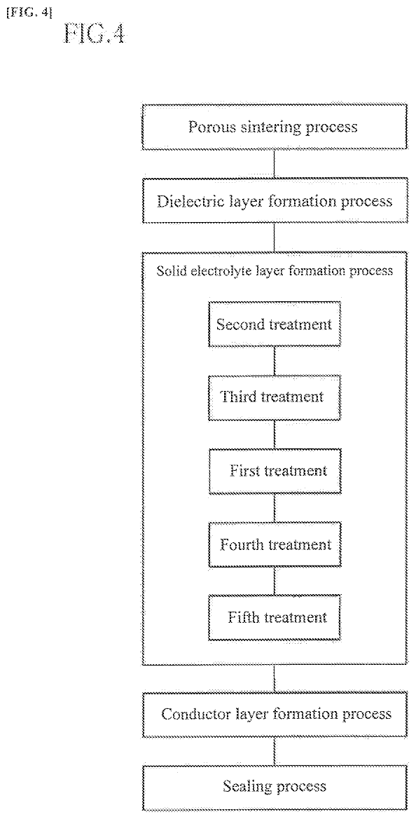

FIG. 4 is a flow diagram illustrating an example of a method of making a solid electrolytic capacitor A1. The method of making the solid electrolytic capacitor A1 of the present embodiment comprises the steps of porous sintering, dielectric layering, solid electrolyte layering, conductor layering, and sealing.

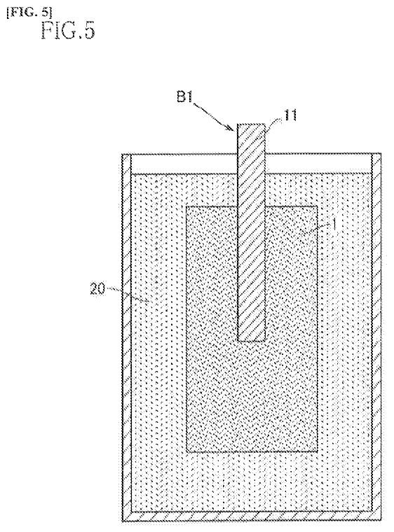

In the step of forming a porous sintered body, a line powder of a valve action metal such as tantalum or niobium is prepared. This fine powder is loaded into a mold together with a wire material of a valve action metal such as tantalum or niobium, which will be the anode wire 11. Then, a porous body in which the wire material is infiltrated is obtained by pressure molding with this mold. A sintering treatment is applied to the porous body and the wire material. This sintering treatment sinters the fine powders of the valve action metal to form a porous sintered body 1 having a large number of pores, resulting in intermediate B1 shown in FIG. 5. The intermediate B1 at this point has a porous sintered body 1 and an anode wire 11.

In the dielectric layer formation step, the anode wire 11 is immersed in a treatment liquid 20, such as a phosphating liquid of an aqueous phosphate solution, while supporting intermediate product B1, for example by holding the anode wire 11. The porous sintered body 1 is then anodized in this treatment solution 20. This forms a dielectric layer 2, such as tantalum pentoxide (Ta₂O₅) or niobium pentoxide (N₂bO₅), on the porous sintered body 1 to cover the outer and inner surfaces of the porous sintered body 1.

In the step of forming a solid electrolyte layer, a solid electrolyte layer 3 is formed on the dielectric layer 2. When forming the solid electrolyte layer 3 of the above-described configuration, the solid electrolyte layer formation step comprises a second treatment, a third treatment, a first treatment, a fourth treatment, and a fifth treatment.

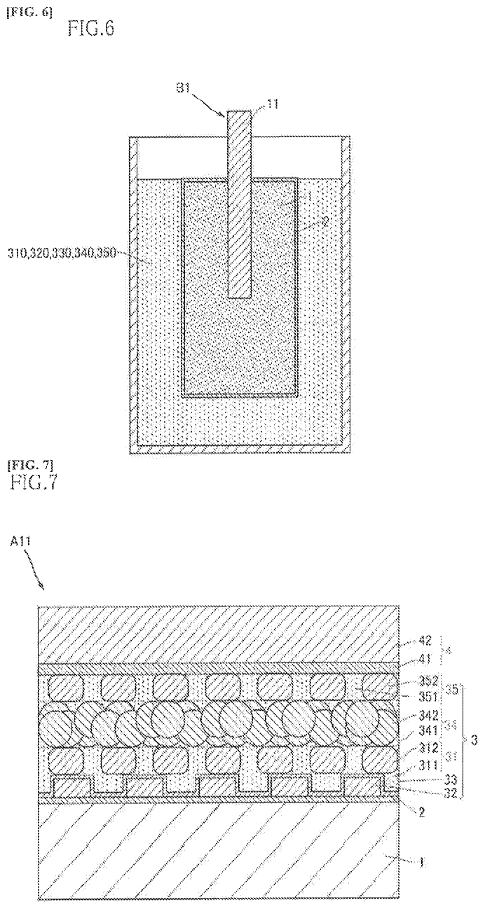

The second treatment is the treatment of forming the second layer 32 on the dielectric layer 2. For example, as shown in FIG. 6, a second treatment solution 320 is attached to the intermediate product B1 in which the dielectric layer 2 is formed. The method of adhering the second treatment solution 320 to the dielectric layer 2 of intermediate product B1 is not particularly limited, and in addition to the immersion shown in FIG. 6, a method capable of adhering to the dielectric layer 2, such as spray application, can be employed. The second treatment solution 320 is a dispersion of conductive polymers or a mixture of self-doped polymers and solvents. The dispersion of conductive polymers consists of, for example, a polymer or copolymer comprising one or two species selected from polypyrroles, polythiophenes, polyaniline, polyfuran, or derivatives based on the substances, and includes various adipic acids, carboxylic acids, sulfonic acids as dopants. Self-doped polymers include conductive polymers based on, for example, polypyrrole, polythiophene, polyaniline, polyfuran, and induced by electron donating groups such as adipic acid, carboxylic acid, sulfonic acid, and the like. Solvents can uniformly disperse or dissolve the conductive polymer, such as water, ethanol, organic solvents, and the like, as appropriate. After the second treatment solution 320 is attached to the dielectric layer 2, the intermediate product B1 is withdrawn from the second treatment solution 320, for example, to dry the second treatment solution 320. This removes the solvent and provides a second layer 32 consisting of a dispersion of conductive polymers or self-doped polymers.

The third treatment is the treatment of forming a third layer 33 on the second layer 32. For example, as shown in FIG. 6, the intermediate product B1 in which the second layer 32 is formed is immersed in the third treatment solution 330. The third treatment solution 330 is, for example, a known monomer solution of the conductive polymer that constitutes the third layer 33 described above. The intermediate product B1 is immersed in the third treatment liquid 330, and the intermediate product B1 is pulled out of the third treatment solution 330 to initiate the chemical polymerization reaction. Then, cleaning and chemical conversion treatment are carried out as necessary. This forms a third layer 33 consisting of a conductive polymer. The third layer 33 of this embodiment covers the second layer 32 and the dielectric layer 2.

The first treatment is the treatment of forming the first layer 31 in the intermediate B1 in which the second layer 32 and the third layer 33 are formed. For example, as shown in FIG. 6, the first treatment solution 310 is deposited onto the intermediate product B1 in which the second layer 32 and the third layer 33 are formed. The first treatment solution 310 corresponds to the first solution of the present disclosure. At this time, the first treatment solution 310 is attached to the third layer 33. Also, if a portion of the dielectric layer 2 and the second layer 32 is exposed from the third layer 33, the first treatment solution 310 may be attached to the exposed portion. In addition, the first treatment solution 310 is filled between the dispersions of the second layer 32. The method of adhering the first treatment solution 310 to intermediate product B1 is not particularly limited, and in addition to the immersion shown in FIG. 6, spray coating, etc. can be used. The first treatment solution 310 is a dispersion of conductive polymers or a mixture of self-doped polymers and electrolytes and solvents. The dispersion of conductive polymers consists of for example, a polymer or copolymer comprising one or two species selected from polypyrroles, polythiophenes, polyaniline, polyfuran, or derivatives based on the substances, and includes various adipic acids, carboxylic acids, sulfonic acids as dopants. Self-doped polymers include conductive polymers based on, for example, polypyrrole, polythiophene, polyaniline, polyfuran, and induced by electron donating groups such as adipic acid, carboxylic acid, sulfonic acid, and the like. Electrolytes include, for example, ethylene glycol, dimethylformamide, γ-butyrolactone, polyethylenealkylene glycol, polyalkylene triol (or derivatives thereof), polymer-based electrolytes, and carbonate-based electrolytes (for example, ethylene carbonate, propylene carbonate, etc.). In addition, it is desirable to have a liquid that does not evaporate due to the temporary heat of reflow as the performance required as an electrolyte. Additives can be used as solutes to improve the conductivity of the electrolyte. Such additives can include, for example, various anions such as adipic acid, carboxylic acid, sulfonic acid, and the like. Solvents can uniformly disperse or dissolve the conductive polymer, such as water, ethanol, organic solvents, and the like, as appropriate. After the first treatment solution 310 is attached to intermediate product B1, the intermediate product B1 is withdrawn from the first treatment solution 310, and the first treatment solution 310 is dried, for example. This removes the solvent to provide a first layer 31 having a conductive polymer 312 consisting of an electrolyte 311 and a dispersion or self-doped polymer of the conductive polymer. Electrolyte 311 is filled between conductive polymers 312 and is in contact with third layer 33. The dispersion of the conductive polymer or the concentration of the self-doped polymer and the electrolyte solution in the first treatment solution 310, and the amount of the first treatment solution 310 attached to the intermediate product B1, etc., are set as appropriate so that the state of the electrolyte solution 311 and the conductive polymer 312 described above can be achieved.

The fourth treatment is the treatment of forming the fourth layer 34 on the first layer 31. For example, as shown in FIG. 6, a fourth treatment solution 340 is attached to the intermediate product B1 in which the first layer 31 is formed. The method of adhering the fourth treatment solution 340 to the first layer 31 of intermediate B1 is not particularly limited, and in addition to the immersion shown in FIG. 6, a method capable of adhering to the dielectric layer 2, such as spray coating, can be employed. The fourth treatment solution 340 is a dispersion of conductive polymers or a mixture of self-doped polymers and solvents. The dispersion of conductive polymers consists of, for example, a polymer or copolymer comprising one or two species selected from polypyrroles, polythiophenes, polyaniline, polyfuran, or derivatives based on the substances, and includes various adipic acids, carboxylic acids, sulfonic acids as dopants. Self-doped polymers include conductive polymers based on, for example, polypyrrole, polythiophene, polyaniline, polyfuran, and induced by electron donating groups such as adipic acid, carboxylic acid, sulfonic acid, and the like. Solvents can uniformly disperse or dissolve the conductive polymer, such as water, ethanol, organic solvents, and the like, as appropriate. After the fourth treatment solution 340 is attached to the first layer 31, the intermediate product B1 is withdrawn from the fourth treatment solution 340, for example, to dry the fourth treatment solution 340. This removes the solvent and results in a fourth layer 34 consisting of a dispersion of conductive polymers or self-doped polymers. It should be noted that by setting the concentration of the dispersion or self-doped polymer of the conductive polymer in the fourth treatment solution 340 and the amount of the fourth treatment solution 340 attached to the first layer 31, etc., as appropriate, in the present embodiment, the density of the dispersion that constitutes the fourth layer 34 is higher than the density of the dispersion or self-dope polymer that constitutes the second layer 32.

The fifth treatment is the treatment of forming the fifth layer 35 on the fourth layer 34. For example, as shown in FIG. 6, a fifth treatment solution 350 is attached to the intermediate product B1 in which the fourth layer 34 is formed. The fifth treatment solution 350 corresponds to the second solution of the present disclosure. At this time, the method of attaching the fifth treatment solution 350 to the fourth layer 34 is not particularly limited, and in addition to the immersion shown in FIG. 6, spray coating, etc. can be used. The fifth treatment solution 350 is a dispersion of conductive polymers or a mixture of self-doped polymers and electrolytes and solvents. The dispersion of conductive polymers consists of, for example, a polymer or copolymer comprising one or two species selected from polypyrroles, polythiophenes, polyaniline, polyfuran, or derivatives based on the substances, and includes various adipic acids, carboxylic acids, sulfonic acids as dopants. Self-doped polymers include conductive polymers based on, for example, polypyrrole, polythiophene, polyaniline, polyfuran, and induced by electron donating groups such as adipic acid, carboxylic acid, sulfonic acid, and the like. Electrolytes include, for example, ethylene glycol, dimethylformamide, γ-butyrolactone, polyethylenealkylene glycol, polyalkylene triol (or derivatives thereof), polymer-based electrolytes, and carbonate-based electrolytes (for example, ethylene carbonate, propylene carbonate, etc.). In addition, it is desirable to have a liquid that does not evaporate due to the temporary heat of reflow as the performance required as an electrolyte. Additives can be used as solutes to improve the conductivity of the electrolyte. Such additives can include, for example, various anions such as adipic acid, carboxylic acid, sulfonic acid, and the like. Solvents can uniformly disperse or dissolve the conductive polymer, such as water, ethanol, organic solvents, and the like, as appropriate. After the fifth treatment solution 350 is attached to the fourth layer 34, the intermediate product B1 is withdrawn from the fifth treatment solution 350, for example, to dry the fifth treatment solution 350. This removes the solvent and results in a fifth layer 35 having a conductive polymer 352 consisting of an electrolyte 351 and a conductive polymer or a self-doped polymer. Electrolyte 351 is present between conductive polymers 352 and is in contact with fourth layer 34.

The conductor layer forming step is a step of forming the conductor layer 4 on the solid electrolyte layer 3. In the present embodiment, the base layer 41 is first formed. The formation of the base layer 41, for example, immerses the porous sintered body 1 in which a solid electrolyte layer 3 is formed in a solution of graphite and an organic solvent, and then dries or sinters it. Subsequently, the top layer 42 is formed. The formation of the top layer 42, for example, causes the intermediate product B1 to immerse in a solution of silver filler and solvent, and then to dry or sinter it after pulling it up. This results in the formation of a top layer 42 consisting of silver and the conductor layer 4.

The sealing step is a step of covering the intermediate product B1 with the sealing resin 5. In the present embodiment, an anode terminal 6 and a cathode terminal 7 are attached to intermediate B1 prior to the sealing step. The anode terminal 6 is installed using known methods such as welding. The attachment of the cathode terminal 7 is done, for example, by bonding with conductive bonding material 71. The seal resin 5 is then formed by mold molding, etc.

Through the above configuration, a solid electrolytic capacitor A1 as shown in FIG. 1-3 is obtained.

Next, the effect of the manufacturing method of solid electrolytic capacitor A1 and solid electrolytic capacitor A1 will be described.

According to the inventors' research, it was found that hydrogen generated in the chemical polymerization would deprive the dielectric layer 2 of oxygen, and if the gaps in the dispersions of self-doped polymers constituting the second layer 32 were filled with conductive polymers formed by the chemical polymerizations constituting the third layer 33, this could result in defects in the dielectric layer 2. According to this embodiment, as shown in FIG. 3, the solid electrolyte layer 3 comprises a first layer 31, the first layer 31 having an electrolyte 311. The electrolyte 311 is filled into the dispersion of conductive polymers or gaps in the self-doped polymers that make up second layer 32. That is, the second layer 32 does not have a structure in which gaps in the conductive polymer dispersion or the self-doped polymer forming the second layer 32 are filled with the conductive polymer formed by chemical polymerization. This makes it possible to suppress defects in the dielectric layer 2, contributing to an improvement in withstand voltage. Also, the electrolyte 311, which is a conductor, is filled in the dispersion of the second layer 32 or the gap of the self-doped polymer. In addition, the electrolyte 311 more easily permeates into the gaps of the dispersion or the self-doped polymer forming the second layer 32 than the treatment solution or the like that forms the conductive polymer by chemical polymerization. This can increase the area of contact between the solid electrolyte layer 3 and the dielectric layer 2. Therefore, it is possible to increase the capacitance of the solid electrolytic capacitor A1. Also, by increasing the contact area between the solid electrolyte layer 3 and the dielectric layer 2, the equivalent series resistance (ESR) of the solid electrolytic capacitor A1 can be reduced.

The first layer 31 has a conductive polymer 312, which allows for a greater amount of electrolyte 311 in the solid electrolyte layer 3 than if the first layer 31 consisted of only the electrolyte 311. This is preferred for larger capacitance capacity.

By providing a fourth layer 34 consisting of a dispersion of conductive polymers or self-doped polymers, it is possible to further promote high voltage resistance and high capacity, and to finish the solid electrolyte layer 3 in a stable form. In addition, by providing a fifth layer 35 having an electrolyte solution 351, it is possible to make more reliable contact between the solid electrolyte layer 3 and the conductor layer 4, and it is preferable for low ESR.

A second layer 32 consisting of a dispersion of conductive polymers or self-doped polymers can be configured to contact dielectric layer 2 to more reliably maintain a close contact between dielectric layer 2 and solid electrolyte layer 3.

FIGS. 7-10 illustrate variations and other embodiments of the present disclosure. In these figures, elements identical or similar to the above embodiments are marked with the same sign as the above embodiments.

FIG. 7 shows a first variant of a solid electrolytic capacitor A1 according to a first embodiment. The solid electrolytic capacitor A11 of this variant differs in configuration from the solid electrolytic capacitor A1 described above in the fourth layer 34.

The fourth layer 34 of the present example has an electrolyte 341 and a conductive polymer 342. The conductive polymer 342 is a dispersion or a self-doped polymer of conductive polymers that constitute the fourth layer 34 of the solid electrolytic capacitor A1 described above. The electrolyte 341 is, for example, an electrolyte 311 of first layer 31 or an electrolyte 351 of fifth layer 35 that has penetrated into the gap of conductive polymer 342. The electrolyte 341 may be composed of only the electrolyte solution 311, or it may be composed of only the electrolyte solution 351, or it may be composed of a mixture of the electrolyte solution 311 and the electrolyte solution 351.

The present variant can also improve the withstand voltage and increase the capacitance of the solid electrolytic capacitor A11. Further, as can be understood from this deformation example, even if the fourth layer 34 is formed from a treatment that does not use a treatment solution containing an electrolyte in the fourth treatment described above, it may be constructed with an electrolyte 341 by infiltration of the electrolyte 311 of the first layer 31 and the electrolyte 351 of the fifth layer 35. In the following embodiments, the configuration of the fourth layer 34 can be combined with either the fourth layer 34 of the solid electrolytic capacitor A1 and the fourth layer 34 of the solid electrolytic capacitor A11.

FIG. 8 illustrates a solid electrolytic capacitor according to a second embodiment of the present disclosure. The solid electrolytic capacitor A2 of this embodiment differs from the embodiments described above in the configuration of the solid electrolyte layer 3.

The solid electrolyte layer 3 of this embodiment does not include the fifth layer 35 described above. For this reason, the fourth layer 34 is in contact with the base layer 41 of the conductor layer 4.

In accordance with this embodiment, it is also possible to improve the withstand voltage and increase the capacitance of the solid electrolytic capacitor A2. Further, as will be appreciated from this embodiment, the solid electrolytic layer 3 may be configured to include the fifth layer 35 or it may be configured to exclude the fifth layer 35. In the following embodiments, a configuration in which the solid electrolyte layer 3 includes the fifth layer 35 and a configuration in which the fifth layer 35 is not included can be selected as appropriate.

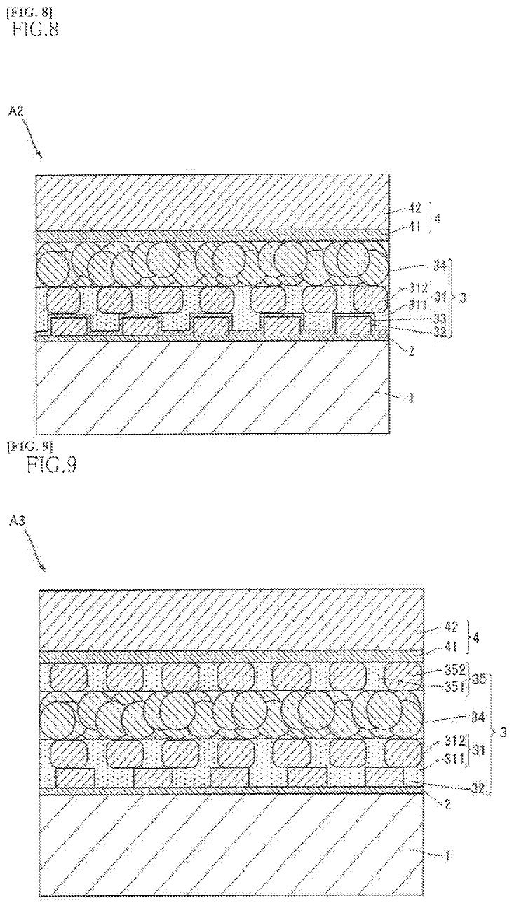

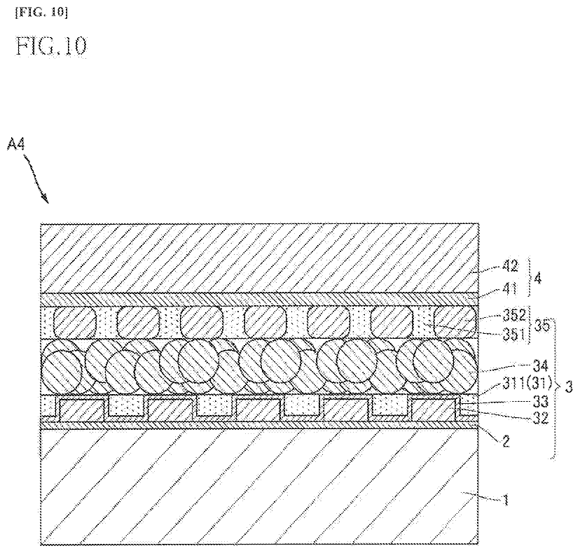

FIG. 9 illustrates a solid electrolytic capacitor according to a third embodiment of the present disclosure. The solid electrolytic capacitor A3 of this embodiment differs from the embodiments described above in the configuration of the solid electrolyte layer 3.

The solid electrolyte layer 3 of this embodiment does not include a third layer 33. For this reason, the second layer 32 and the first layer 31 are in contact. More specifically, there are a form in which the electrolytic solution 311 of the first layer 31 directly covers the second layer 32, and a form in which the conductive polymer 312 of the first layer 31 is in contact with the second layer 32.

In accordance with this embodiment, it is also possible to improve the withstand voltage and increase the capacitance of the solid electrolytic capacitor A3. Further, according to research by the inventors, it is possible to further increase the withstand voltage by not providing the third layer 33. In the embodiments below, a configuration in which the solid electrolyte layer 3 includes the second layer 32 and a configuration in which the second layer 32 is not included can be selected as appropriate.

FIG. 10 illustrates a solid electrolytic capacitor according to a fourth embodiment of the present disclosure. The solid electrolytic capacitor A4 of this embodiment differs from the embodiments described above in the configuration of the first layer 31. The first layer 31 of this embodiment does not contain a conductive polymer 312. The first layer 31 is composed of the electrolyte solution 311 only. Thus, the fourth laver 34 is in the form of contact with the third layer 33.

In accordance with this embodiment, it is also possible to improve the withstand voltage and increase the capacitance of the solid electrolytic capacitor A4. Even if the first layer 31 is configured without the conductive polymer 312, the capacitance can be increased if the dispersion or self-doped polymer gap that constitutes the third layer 33 is realized in a form in which the electrolyte solution 311 is filled.

The solid electrolytic capacitor and the method for manufacturing the solid electrolytic capacitor according to the present disclosure are not limited to the above described embodiments. The specific configuration of the solid electrolytic capacitor and the method for manufacturing the solid electrolytic capacitor according to the present disclosure can be changed in various designs. The present disclosure includes embodiments described in the following appendices.

### APPENDIX 1

A porous sintered body comprising an anode;
A dielectric layer formed on the porous sintered body;
A solid electrolyte layer formed on the dielectric layer;
A conductor layer formed on the solid electrolyte layer and constituting a cathode;
A solid electrolyte layer comprising a first layer formed on the dielectric layer;
and a first layer comprising of an electrolyte solution.

### APPENDIX 2

A solid electrolytic capacitor according to Appendix 1 with the electrolyte solution of the first layer comprising of at least one selected from the group consisting of ethylene glycol, dimethylformamide, γ-butyrolactone, polyalkylene glycol, polyalkylenetriol, and their derivatives thereof, and at least one of a polymer-based electrolyte solution, or a carbonate-based electrolyte.

### APPENDIX 3

The solid electrolytic capacitor according to Appendix 2, wherein at least one of adipic acid, carboxylic acid, and sulfonic acid is added as an anion to the electrolyte solution.

### APPENDIX 4

The solid electrolytic capacitor according to any one of Appendices 1 to 3, wherein the first layer contains a dispersion of a conductive polymer or a self-doped polymer.

### APPENDIX 5

A solid electrolytic capacitor as described in Appendix 4 having the first layer comprising of a polymer or copolymer containing one or two selected from polypyrrole, polythiophene, polyaniline, polyfuran, or derivatives having these as a basic skeleton, and containing adipic acid, carboxylic acid, or sulfonic acid as a dopant; and
A dispersion comprising of a polymer or copolymer, or a self-doped polymer comprising of a conductive polymer having polypyrrole, polythiophene, polyaniline, or polyfuran as the basic skeleton, and induced by electron donating groups such as adipic acid, carboxylic acid, sulfonic acid, and the like

### APPENDIX 6

A solid electrolytic capacitor according to Appendix 1 wherein the solid electrolyte layer includes a second layer formed on the dielectric layer and having a dispersion of a conductive polymer or a self-doped polymer, and a second layer covering a portion of the dielectric layer, and where the electrolyte is filled between the dispersion or the self-doped polymer of the second layer.

### APPENDIX 7

A solid electrolytic capacitor as described in Appendix 6 having the second layer comprising of a polymer or copolymer containing one or two selected from polypyrrole, polythiophene, polyaniline, polyfuran, or derivatives having these as a basic skeleton, and containing adipic acid, carboxylic acid, or sulfonic acid as a dopant; and
A dispersion comprising of a polymer or copolymer, or a self-doped polymer comprising of a conductive polymer having polypyrrole, polythiophene, polyaniline, or polyfuran as the basic skeleton, and induced by electron donating groups such as adipic acid, carboxylic acid, sulfonic acid, and the like.

### APPENDIX 8

The solid electrolytic capacitor according to Appendix 6 or 7, wherein the solid electrolyte layer comprises a third layer interposed between the first layer and the second layer and comprised of a conductive polymer.

### APPENDIX 9

A solid electrolytic capacitor as described in Appendix 8 having the third layer comprising of a polymer or copolymer containing one or two selected from polypyrrole, polythiophene, polyaniline, polyfuran, or derivatives having these as a basic skeleton, and containing adipic acid, carboxy lie acid, or sulfonic acid as a dopant; and
A self-doped polymer comprising of a polymer or copolymer, or a conductive polymer having polypyrrole, polythiophene, polyaniline, or polyfuran as the basic skeleton, and induced by electron donating groups such as adipic acid, carboxylic acid, sulfonic acid, and the like.

### APPENDIX 10

The solid electrolytic capacitor of Appendix 8 or 9, wherein the solid electrolyte layer includes a fourth layer interposed between the first layer and the conductor layer and having a dispersion of a conductive polymer or a self-doped polymer.

### APPENDIX 11

A solid electrolytic capacitor as described in Appendix 10 having the fourth layer comprising of a polymer or copolymer containing one or two selected from polypyrrole, polythiophene, polyaniline, polyfuran, or derivatives having these as a basic skeleton, and containing adipic acid, carboxylic acid, or sulfonic acid as a dopant; and
A dispersion comprising of a polymer or copolymer, or a self-doped polymer comprising of a conductive polymer having polypyrrole, polythiophene, polyaniline, or polyfuran as the basic skeleton, and induced by electron donating groups such as adipic acid, carboxylic acid, sulfonic acid, and the like.

### APPENDIX 12

The solid electrolytic capacitor of Appendix 10 or 11, wherein the solid electrolyte layer comprises a fifth layer interposed between the fourth layer and the conductor layer and having a dispersion of a conductive polymer or a self-doped polymer and an electrolyte solution.

### APPENDIX 13

A solid electrolytic capacitor as described in Appendix 12 having a fifth layer comprising of a polymer or copolymer containing one or two selected from polypyrrole, polythiophene, polyaniline, polyfuran, or derivatives having these as a basic skeleton, and containing adipic acid, carboxylic acid, or sulfonic acid as a dopant; and
A dispersion comprising of a polymer or copolymer, or a self-doped polymer comprising of a conductive polymer having polypyrrole, polythiophene, polyaniline, or polyfuran as the basic skeleton, and induced by electron donating groups such as adipic acid, carboxylic acid, sulfonic acid, and the like; and
An electrolyte solution of the fifth layer comprising of at least one selected from the group consisting of ethylene glycol, dimethylformamide, γ-butyrolactone, polyalkylene glycol, polyalkylenetriol, and their derivatives thereof, and at least one of a polymer-based electrolyte solution, or a carbonate-based electrolyte solution.

### APPENDIX 14

The solid electrolytic capacitor according to Appendix 13, wherein at least one of adipic acid, carboxylic acid, and sulfonic acid is added as an anion to the electrolyte solution.

### APPENDIX 15

A method for manufacturing a solid electrolytic capacitor includes the steps of:
forming a porous sintered body constituting an anode;
forming a dielectric layer on the porous sintered body;
forming a solid electrolyte layer on the dielectric layer; and
forming a conductor layer constituting a cathode on the solid electrolyte layer; and the step of forming the solid electrolyte layer includes a first treatment of forming the first layer using a first liquid containing an electrolyte solution.

### APPENDIX 16

The method of manufacturing a solid electrolytic capacitor according to Appendix 15, wherein the first liquid comprises a conductive polymer and an electrolyte.

### APPENDIX 17

A method for manufacturing a solid electrolytic capacitor according to Appendix 16 wherein the step of forming the solid electrolyte layer includes a second treatment of forming a second layer having a conductive polymer dispersion or a self-doped polymer on the dielectric layer before the first treatment, and where the second layer covers a portion of the dielectric layer, and in the first treatment, the electrolytic solution is filled between the dispersion or the sell-doped polymer of the second layer.

### APPENDIX 18

A method of manufacturing a solid electrolytic capacitor according to Appendix 17, wherein the step of forming the solid electrolyte layer includes a third treatment of forming a third layer made of a conductive polymer on the second layer by chemical polymerization after the second treatment and before the first treatment.

### APPENDIX 19

A method of manufacturing a solid electrolytic capacitor according to Appendix 18, wherein the step of forming the solid electrolyte layer includes a fourth treatment of forming a fourth layer having a conductive polymer dispersion or a self-doped polymer on the first layer after the first treatment.

### APPENDIX 20

A method of manufacturing a solid electrolytic capacitor according to Appendix 19, wherein the step of forming the solid electrolyte layer comprises a fifth treatment in which a second solution comprising a conductive polymer or a self-doped polymer and an electrolyte is attached to the fourth layer after the fourth treatment.

### REFERENCE SIGNS LIST

| A1, A11, A2, A3, A4: Solid electrolytic capacitor | | | |
|---|---|---|---|
| B1: | Intermediate product | 1: | Porous sintered body |
| 2: | Dielectric layer | 3: | Solid electrolyte layer |
| 4: | Conductor layer | 5: | Sealing resin |
| 6: | Anode terminal | 7: | Cathodic terminal |
| 11: | Anode wire | 20: | Treatment solution |
| 31: | First layer | 32: | Second layer |
| 33: | Third layer | 34: | Fourth layer |
| 35: | Fifth layer | 41: | Base layer |
| 42: | Top layer | 71: | Electrically conductive |
| | | | bonding material |
| 310: | First treatment | 311: | Electrolyte solution |
| | solution | | |
| 312: | Dispersion | 320: | Second treatment |
| | | | solution |
| 330: | Third treatment | 340: | Fourth treatment |
| | solution | | solution |
| 341: | Electrolyte solution | 342: | Dispersion |
| 350: | Fifth treatment | 351: | Electrolyte solution |
| | solution | | |
| 352: | Dispersion | | |

1. A porous sintered body comprising an anode;
A dielectric layer formed on the porous sintered body;
A solid electrolyte layer formed on the dielectric layer;
A conductor layer formed on the solid electrolyte layer and constituting a cathode;
A solid electrolyte layer comprising a first layer formed on the dielectric layer;
and a first layer comprising of an electrolyte solution.

2. A solid electrolytic capacitor according to claim 1, wherein the electrolytic solution of the first layer consists of at least one selected from the group consisting of ethylene glycol, dimethylformamide, γ-butyrolactone, polyalkylene glycol, polyalkylenetriol, and their derivatives thereof, and at least one of a polymer-based electrolyte solution, or a carbonate-based electrolyte solution.

3. A solid electrolytic capacitor according to claim 2, wherein at least one of adipic acid, carboxylic acid, and sulfonic acid is added as an anion to the electrolytic solution.

4. A solid electrolytic capacitor of claim 1, wherein the first layer comprises a dispersion or a self-doped polymer consisting of a conductive polymer.

5. A solid electrolytic capacitor according to claim 4, wherein the first layer comprises
of a polymer or copolymer containing one or two selected from polypyrrole, polythiophene, polyaniline, polyfuran, or derivatives having these as a basic skeleton, and containing adipic acid, carboxylic acid, or sulfonic acid as a dopant;
and a dispersion comprising of a polymer or copolymer, or a self-doped polymer comprising of a conductive polymer having polypyrrole, polythiophene, polyaniline, or polyfuran as the basic skeleton, and induced by electron donating groups such as adipic acid, carboxylic acid, sulfonic acid, and the like.

6. A solid electrolytic capacitor according to claim 1 wherein the solid electrolyte layer includes a second layer formed on the dielectric layer having a dispersion of a conductive polymer or a self-doped polymer, and a second layer covering a portion of the dielectric layer, and an electrolyte filled between the dispersion or the self-doped polymer of the second layer.

7. A solid electrolytic capacitor according to claim 6, wherein the second layer comprises of a polymer or copolymer containing one or two selected from polypyrrole, polythiophene, polyaniline, polyfuran, or derivatives having these as a basic skeleton, and containing adipic acid, carboxylic acid, or sulfonic acid as a dopant; and a dispersion comprising of a polymer or copolymer, or a self-doped polymer comprising of a conductive polymer having polypyrrole, polythiophene, polyaniline, or polyfuran as the basic skeleton, and induced by electron donating groups such as adipic acid, carboxylic acid, sulfonic acid, and the like.

8. A solid electrolytic capacitor according to claim 6, wherein the solid electrolyte layer comprises a third layer interposed between the first layer and the second layer and comprised of a conductive polymer.

9. A solid electrolytic capacitor according to claim 8, wherein the third layer comprises of a polymer or copolymer containing one or two selected from polypyrrole, polythiophene, polyaniline, polyfuran, or derivatives having these as a basic skeleton, and containing adipic acid, carboxylic acid, or sulfonic acid as a dopant; and a self-doped polymer comprising of a polymer or copolymer, or a conductive polymer having polypyrrole, polythiophene, polyaniline, or polyfuran as the basic skeleton, and induced by electron donating groups such as adipic acid, carboxylic acid, sulfonic acid, and the like.

10. A solid electrolytic capacitor according to claim 8, wherein the solid electrolyte layer comprises a fourth layer interposed between the first layer and the conductor layer and having a dispersion or self-doped polymer comprised of a conductive polymer.

11. A solid electrolytic capacitor according to claim 10, wherein the fourth layer comprises of a polymer or copolymer containing one or two selected from polypyrrole, polythiophene, polyaniline, polyfuran, or derivatives having these as a basic skeleton, and containing adipic acid, carboxylic acid, or sulfonic acid as a dopant; and a dispersion comprising of a polymer or copolymer, or a self-doped polymer comprising of a conductive polymer having polypyrrole, polythiophene, polyaniline, or polyfuran as the basic skeleton, and induced by electron donating groups such as adipic acid, carboxylic acid, sulfonic acid, and the like.

12. A solid electrolytic capacitor according to claim 10, wherein the solid electrolyte layer comprises a fifth layer interposed between the fourth layer and the conductor layer and having a dispersion or self-doped polymer comprised of a conductive polymer and an electrolyte solution.

13. A solid electrolytic capacitor according to claim 12, wherein the fifth layer comprises of a polymer or copolymer containing one or two selected from polypyrrole, polythiophene, polyaniline, polyfuran, or derivatives having these as a basic skeleton, and containing adipic acid, carboxylic acid, or sulfonic acid as a dopant; a dispersion comprising of a polymer or copolymer, or a self-doped polymer comprising of a conductive polymer having polypyrrole, polythiophene, polyaniline, or polyfuran as the basic skeleton, and induced by electron donating groups such as adipic acid, carboxylic acid, sulfonic acid, and the like; an electrolyte solution of the fifth layer comprising of at least one selected from the group consisting of ethylene glycol, dimethylformamide, γ-butyrolactone, polyalkylene glycol, polyalkylenetriol, and their derivatives thereof, and at least one of a polymer-based electrolyte solution, or a carbonate-based electrolyte solution.

14. A solid electrolytic capacitor according to claim 13, wherein at least one of adipic acid, carboxylic acid, and sulfonic acid is added as an anion to the electrolyte solution.

15. A method for manufacturing a solid electrolytic capacitor that includes the steps of:
forming a porous sintered body constituting an anode,
forming a dielectric layer on the porous sintered body,
forming a solid electrolyte layer on the dielectric layer, and
forming a conductor layer constituting a cathode on the solid electrolyte layer; and the step of forming the solid electrolyte layer includes a first treatment of forming the first layer using a first liquid containing an electrolyte solution.

16. A method of manufacturing a solid electrolytic capacitor according to claim 15, wherein the first liquid comprises a conductive polymer and an electrolyte.

17. A method for manufacturing a solid electrolytic capacitor according to claim 16 wherein the step of forming the solid electrolyte layer includes a second treatment of forming a second layer having a conductive polymer dispersion or a self-doped polymer on the dielectric layer before the first treatment, and wherein the second layer covers a portion of the dielectric layer, and in the first treatment, the electrolyte is filled between the dispersion or the self-doped polymer of the second layer.

18. A method of manufacturing a solid electrolytic capacitor according to claim 17, wherein the step of forming the solid electrolyte layer includes a third treatment of forming a third layer made of a conductive polymer on the second layer by chemical polymerization after the second treatment and before the first treatment.

19. A method of manufacturing a solid electrolytic capacitor according to claim 18, wherein the step of forming the solid electrolyte layer includes a fourth treatment of forming a fourth layer having a dispersion or a self-doped polymer of conductive polymer on the first layer after the first treatment.

20. A method of manufacturing a solid electrolytic capacitor according to claim 19, wherein the step of forming the solid electrolyte layer includes a fifth treatment in which a second solution comprising of a conductive polymer or a self-doped polymer and an electrolyte is attached to the fourth layer after the fourth treatment.
